(19) United States
(12) Patent Application Publication
(10) Pub. No.: US 2026/0316328 A1
(43) Pub. Date: Oct. 15, 2026

(54) BOARD MATERIAL, METHOD FOR MANUFACTURING SUCH BOARD MATERIAL AND DECORATIVE PANEL COMPRISING SUCH BOARD MATERIAL

(71) Applicant: UNILIN, BV, Wielsbeke (BE)

(72) Inventors: Benjamin CLEMENT, Wielsbeke (BE); Benny SCHACHT, Wielsbeke (BE)

(21) Appl. No.: 19/491,551

(22) PCT Filed: Jun. 24, 2024
(86) PCT No.: PCT/IB2024/056126

§ 371 Date: Dec. 9, 2025

Related U.S. Application Data
(60) Provisional application No. 63/510,656, filed on Jun. 28, 2023.
(60) Provisional application No. 63/515,138, filed on Jul. 24, 2023.
(60) Provisional application No. 63/551,556, filed on Feb. 9, 2024.

(51) Int. Cl. B27N 3/04; B27N 1/00; B27N 3/00

(52) U.S. Cl. CPC B27N 3/04; B27N 1/00; B27N 3/002

(57) ABSTRACT

A board material including plant particles having a coating on a surface thereof, wherein the plant particles are pressed and bound together with a glue. A method for manufacturing such board material, and a decorative panel include a substrate layer obtained from such board material. Alternatively, the board material includes plant particles, wherein the plant particles have a charred surface and are pressed and bound together with a glue.

The present invention relates to board materials, decorative panels and methods for manufacturing board material. The decorative panels of the invention are in the first place destined for application as floating floor panels, but may also be applied otherwise. For example as glued down floor panels, or as wall or ceiling or furniture or construction panels.

WO 97/47834 describes a laminate floor panel for assembling a floating floor covering. The floor panel, as described herein, has as a disadvantage that the applied substrate, more in particular the MDF or HDF substrate (Medium Density Fiberboard or High Density Fiberboard) is prone to damage by moisture.

EP 1 938 963 discloses a floor panel based on synthetic material, more particularly soft polyvinyl chloride (PVC). The floor panels may be obtained at least by lamination of several synthetic foils. EP 3 405 346 discloses a floor panel of a high density filled polyvinyl chloride material. The floor panels may be obtained at least by extrusion. In both EP'963 and the EP'346 the floor panels are provided with a decorative top layer comprising PVC. The floor panels of EP'963 and EP'346 may be more water resistant than the panels of WO'834. The use of PVC, plasticizers and/or other additives may, however, at least in some cases, be harmful to the environment.

From WO 2017/122149, it is known to use a PET (polyethylene terephthalate) composition as a substrate in a flooring panel, wherein the substrate may be formed at least by means of extrusion. From WO 2014/111192, it is known to use a thermoplastic composition comprising PP (polypropylene) as a substrate in a decorative panel. Panels comprising a substrate with PET or PP may be particularly prone to deformation in changing ambient conditions, due to their crystallinity.

The present invention in the first place seeks to provide an alternative board material, wherein, in accordance with preferred embodiments, a solution is provided for one or more of the problems with the board materials and/or the decorative panels of the state of the art.

The description mentions weight percentages. Said weight percentages are preferably dry matter weight percentages, unless otherwise indicated.

With this aim, the present invention in accordance with its first aspect, is a board material comprising plant particles, wherein said plant particles comprise a coating on a surface thereof, and wherein said plant particles are pressed and bound together with a glue. The coating on said surface may to a certain extent shield the plant particles from humidity, water or vapor. Said plant particles comprising a coating on a surface thereof, are thus coated plant particles obtained by applying a coating material on said plant particles. Said coated plant particles are further pressed and bound together with the aid of, among others, said glue. The board material can for example be a plate-shaped material, e.g. a plate, which can be used for construction purposes or that can be further processed into a panel, such as a decorative panel, wherein for example the substrate of said decorative panel is derived from said plate. Said board material is preferably plate-shaped and can be one-layered or can comprise two sublayers, three sublayers or more sublayers. Thus the invention preferably relates to a plate comprising coated plant particles and a glue, wherein said glue bonds said coated plant particles together. Said coating can or cannot at least partially penetrate the plant particles. Said coated plant particles can thus also be impregnated plant particles.

Preferably said coating forms chemical bonds, for example covalent bonds, with chemical end groups of the plant particles. As such, chemical end groups of the plant particles are blocked, and the plant particles are shielded from moisture/water. For example possible hydroxyl groups of said plant particles are blocked by said coating.

Said coating can also form physical bonds with the plant particles.

Preferably said glue forms chemical bonds, for example covalent bonds, with the coated plant particles as such forming a board material with high strength and stability.

Said plant particles can also be indicated as vegetable particles, preferably said plant particles comprise cellulosic material, for example lignocellulosic material. The plant particles are preferably lignocellulose particles, more preferably wood particles, such as wood fibers and/or wood chips and/or wood shavings.

Said plant particles can be obtained from fresh plants, e.g. fresh wood, but can also comprise a certain amount of recycled material or can only comprise recycled material. For example at least a part of said plant particles can be obtained from production waste or post-consumer products comprising particle board, wood fiber board, solid wood, etc. Said recycled material can comprise fibers obtained from recycling wood fiberboard containing material, such as medium density fiberboard (MDF) or high density fiberboard (HDF), for example by a process as described in WO 2021/176326. Said recycled material can comprise comminuted particles derived from particle board containing material. Said recycled material can comprise comminuted particles from old solid wood containing products. When making use of recycled material, said coating can encapsulate said recycled material and as such encapsulate any unwanted components and/or impurities present in said recycled material.

To obtain said coated plant particles, for example coated plant fibers, preferably between 1 and 40 weight percentage of coating material, and this preferably based upon the dry weight of said plant particles, can be added to non-coated plant particles. Said weight percentage is preferably based upon dry matter weight, such that the weight percentage of coating material upon plant particles, is the dry matter weight of the coating material upon the dry matter weight of the plant particles. Thus between 1 and 40 g of dry weight coating material can be added per 100 g of dry weight plant particles. Further preferably the weight ratio of the coating material to the dry weight of said plant particles is between 10% and 40%, for example between 15% and 25%, is for example 20%.

To glue said coated plant particles together, preferably between 5 and 30 weight percentage of glue, and this preferably based upon the dry weight of said plant particles or based upon the dry weight of the coated plant particles, can be used. Said weight percentage is preferably based upon dry matter weight, such that the weight percentage of glue upon plant particles, is the dry matter weight of the glue upon the dry matter weight of the (coated) plant particles. Thus between 5 and 30 g of dry weight glue can be added per 100 g of dry weight (coated) plant particles. More preferably between 5 and 30 weight percentage of glue, and this based upon the dry weight of said plant particles is used, for example between 10 and 25 weight percentage of glue. With the aid of said coated plant particles, the amount of glue needed to have the desired water resistance characteristics of the board material, can be reduced.

Preferably the board material comprises at least 50 weight percentage of plant particles based upon the total weight of the board material, preferably at least 60 wt %, more preferably at least 70 wt %. With the aid of said coating and said glue, board material comprising the desired characteristics and having a high amount of plant particles, can be obtained.

Preferably, said plant particles comprise particles in fiber form, such as lignocellulose fibers, or in particulate form, such as lignocellulose chips or lignocellulose shavings. The plant particles can comprise wood fibers and/or wood chips and/or wood flakes and/or wood shavings. In the cases where said plant particles comprise wood fibers, said wood fibers preferably have an aspect ratio (length:diameter) of at least 25, preferably between 25 and 100. Said aspect ratio can be a number average aspect ratio or substantially all said wood fibers, for example at least 98 weight percentage of said wood fibers, can have an aspect ratio of between 25 and 100. Preferably the average length of said wood fibers is at least 300 μm, or at least 1000 μm. The aspect ratio and/or the average length of said wood fibers results in an enhanced integrity of the obtained board material even when water is absorbed. Further, absorption of water in wood fibers tends to swell the wood fiber, leading to a thicker diameter, but the length of the fibers is only marginally affected. By having a length that is at least 25 times the diameter, the impact of water absorption on swelling of the board material can be limited.

Preferably, said plant particles comprise particles of a wood species having a density at 12% moisture of at least 400 kg/m³ or at least 500 kg/m³. Said density is preferably an average density. Such wood species are naturally less porous and less prone to absorption of water.

Preferably, said plant particles comprise particles of soft wood. Soft wood is more abundant and quicker growing than hardwood, and the present invention allows to obtain an excellent board quality, from the point of view of water resistance, also when soft wood is used in the board material. With soft wood, the coating may even be partially absorbed into the surface of the plant particles, for example absorbed into the surface of the plant fibers, to yield an even better barrier against water absorption at the locations where said coating is present. With soft wood is preferably indicated wood from gymnosperm trees such as conifers. With hard wood is preferably indicated wood from angiosperms.

Preferably, the plant particles in said board materials are essentially or exclusively obtained from wood, preferably either softwood or hardwood. Limiting the particles to only soft wood or only hard wood leads to a better controllable application of the coating of the respective particles, and a resulting repeatable water resistance. Of course embodiments where specific ratios between softwood or hardwood are used, are also possible. By having said specific ratios, a good controllable application of the coating of the respective particles, and a resulting repeatable water resistance, can be obtained.

In other embodiments, said plant particles comprise particles of hemp, bamboo and/or miscanthus. These plant particles are obtained from fast growing and easily renewable plants.

The plant particles can also be modified plant particles. For example the plant particles can be acetylated and/or delignified and/or thermally modified and/or silanized. These plant particles are then preferably treated, e.g. acetylated and/or delignified and/or thermally modified and/or silanized, before coating said plant particles with said coating. The plant particles can also be treated with polyethylene glycol or isocyanate, as such forming modified plant particles, and this preferably before coating said plant particles with said coating. Said treatments, e.g. acetylation and/or delignification and/or thermally modifying and/or silanization and/or treating with polyethylene glycol or treating with isocyanate, to form said modified plant particles, can take place at different locations, for example the lumber can undergo said treatment, or said treatment can take place after debarking, after comminuting the wood or recycled wood products—e.g. after refining of the wood to form wood fibers or after comminuting old particle boards—, during transport of the wood particles—e.g. in a blowline—.

The coating can comprise one or more of the following list: an acrylic coating, a polyurethane dispersion (PUD), an isocyanate coating such as a methylene diphenyl diisocyanate (MDI) coating or a polymeric diphenyl diisocyanate (pMDI) coating, an epoxy coating, a vinyl ester coating, a bio-based coating—e.g. based upon sugar, lignin, flour and/or hyperbranched polyamides—, a styrene butadiene coating—e.g. a styrene butadiene copolymer coating—, an acrylate coating—such as an emulsion of acrylate or a styrene acrylate, a latex modified acrylate—, an epoxy resin, an alkyd resin—such as an polyurethane modified alkyd—, a silicon containing coating—such as polysiloxanes, polydimethylsiloxane, polysilazanes, polysilanes—. Said coatings can or cannot be modified coatings, with modified indicating that additional functional groups are present which can react with the wood and/or the glue. An example of such a modified coating is a carboxylated styrene-butadiene copolymer coating.

In a preferred embodiment the coating is or comprises a (carboxylated) styrene butadiene copolymer, said styrene butadiene copolymer coating preferably being water based. Very good results for resistance against swelling and for dimensional stability were obtained, especially in combination with a glue which is an isocyanate glue—e.g. an MDI glue- or an acrylate glue or a glue which is a combination of an isocyanate glue—e.g. an MDI glue- and an acrylate glue. The coating can for example be an anionic carboxylated styrene-butadiene copolymer containing latex.

Very good results were obtained when the coating is or comprises an acrylic ester-styrene copolymer.

In another preferred embodiment the coating is an epoxy coating. Very good results for resistance against swelling and for dimensional stability were obtained, especially in combination with a glue which is an isocyanate glue—e.g. an (p)MDI glue- or an acrylate glue or a glue which is a combination of an isocyanate glue—e.g. an (p)MDI glue- and an acrylate glue. Very good results were also obtained when the coating is a combination of epoxy and amine-functionalized silicon-containing compounds, such as polysiloxanes or polysilazanes or polysilanes. Said coating can comprise more epoxy compounds then silicon containing compounds based on weight, however equal amounts of epoxy compounds and silicon containing compounds based on weight can be used. The epoxy coating can be a two component system, said epoxy coating for example comprising an epoxy compound and an amine hardener.

In another preferred embodiment the coating comprises a silicon containing compound, such as fumed silica or siloxanes or polysiloxanes or polysilazanes or polysilanes. For example the coating can be an epoxy coating comprising amine-functionalized silicon containing compounds, said silicon containing compounds preferably (partially) replacing amine hardeners. Said epoxy coating then ensures good encapsulating of said plant particles, while said silicon containing compounds provide adhesion of said coating to said plant particles and further enhance the water-repellent characteristics of said coated plant particles. For example the coating as such can be polysiloxanes. For example fumed silica can be added in powder form to a coating as an additive.

In another preferred embodiment the coating comprises a metallic soap as an additive. Said metallic soaps preferably comprise an aliphatic chain comprising at least 8 carbons, more preferably at least 12 carbons and most preferably at least 16 carbons. More preferably said metallic soaps also comprise one, two or more shorter aliphatic chains, e.g. aliphatic chains with at most 6 carbons, preferably at most 4 carbons. Said metallic soaps can be obtained from animal fats or plant/vegetable fats. The metallic soaps are preferably zinc metallic soaps or calcium metallic soaps or magnesium metallic soaps. An example of possible metallic soaps is zinc stearate. Metallic soaps can contribute to the soap resistance of the board material. Said coatings comprising metallic soaps as additive can be a styrene butadiene copolymer coating.

In a specific embodiment the coating is an acrylate coating and the glue is an isocyanate glue such as MDI or pMDI. A thermo initiator and/or photo initiator can be present in the acrylate coating to cure said coating.

The glue can comprise one or more from the following list: an acrylic glue, a polyurethane dispersion (PUD), an isocyanate glue such as a methylene diphenyl diisocyanate (MDI) glue or a polymeric diphenyl diisocyanate (pMDI) glue, an epoxy glue, a vinyl ester glue, a bio-based glue—e.g. based upon sugar, lignin, flour and/or hyperbranched polyamides—, a styrene butadiene glue, a formaldehyde based glue such as urea formaldehyde glue (UF), melamine ureaformaldehyde glue (MUF), melamine formaldehyde glue (MF), melamine urea formaldehyde phenol glue (MUPF), phenol formaldehyde glue (PF).

In a preferred embodiment the glue is an MF glue. Very good results for resistance against swelling were obtained with MF glue.

In another preferred embodiment the glue is an MDI glue or a pMDI glue. Very good results for resistance against swelling and for dimensional stability were obtained with an MDI glue and with a pMDI glue.

In a very preferred embodiment the glue is an acrylate based glue, such as an acrylate glue, a methacrylate glue, an epoxy acrylate glue or an epoxy methacrylate glue. Excellent results for dimensional stability were obtained with acrylate based glues.

In a specific embodiment the glue is a combination of an MDI glue and an acrylate based glue, for example as mentioned in the paragraph above, wherein said glue preferably has equals amounts, based on weight, of said MDI glue and said acrylate based glue. Here good dimensional stability can be obtained with a more sustainable glue.

In a specific embodiment the glue comprises wax, such as paraffin wax.

Preferably, said glue has a composition different from said coating. In this manner, the coating composition can be chosen to provide the plant particles with optimal resistance against swelling and the glue composition can be chosen for its optimal bonding properties.

Preferably, said coating is applied on at least 50% of the surface of said particles. Even more preferably, said coating encapsulates said particles, meaning that approximately 100% of the surface of said plant particles is covered by said coating. It is clear that the larger the surface covered by said coating, the more effective the shielding of the particles will be, for example towards water absorption and the subsequent deterioration or swelling.

Preferably said coating forms a film layer upon said plant particles, said film layer preferably having a thickness of at most 50 μm, preferably at most 10 μm, more preferably at most 5 μm and/or having a thickness of at least 1 μm, preferably at least 3 μm. With such thin film layers, the amount of coating material needed can be limited.

Preferably, said coating is moisture cured or moisture curable. For example said coating may be obtained from a moisture cured isocyanate prepolymer and/or be based on methylene diphenyl diisocyanate and polyether polyol. A good option for the coating is the use of the substance marketed as Suprasec® 9577 by Huntsman. The benefit of having a moisture cured or moisture curable coating, is that curing can take place directly after applying said coating and this for example with the aid of moisture present in the surrounding air. Also said board material is normally obtained by gluing said coated plant particles and pressing the whole, wherein said glue can comprise water and/or water can be released during the curing of said glue, such that also said coating can get cured during said gluing and/or pressing.

Preferably, said coating is radiation cured or radiation curable. For example the coating can be cured/is curable by ultraviolet radiation, infrared radiation or near infrared radiation. This can for example be the case for acrylate based coatings. A radiation cured or radiation curable coating can be easily (partially) cured before gluing said coated plant particles together. This way it is ensured that the plant particles remain encapsulated by said cured coating during manufacturing of said board material, e.g. during gluing of said plant particles and pressing the whole together to form a board material.

Preferably, said coating comprises cured pMDI (polymeric methylene diphenyl diisocyanate).

In a specific embodiment the board material comprises a thermoplastic material. For example said thermoplastic material can take up between 1 wt % and 15 wt % based upon dry weight of plant particles, for example 10 wt %, preferably between 3 wt % and 7 wt %, for example 5 wt %. If said thermoplastic material takes up between 1 wt % and 5 wt % based upon dry weight of plant particles, this thermoplastic material can be considered as an additive, such that this thermoplastic material is also described as a possible additive further in this description. Examples of possible thermoplastic materials are polyvinyl butyral (PVB) and/or ethylene vinyl acetate (EVA) and/or polyvinyl alcohol (PVA) and/or polybutylene succinate (PBS). Other examples of possible thermoplastic material are polyvinyl chloride (PVC), polymethyl methacrylate (PMMA), polyurethane (PU), polypropylene (PP), polyethylene (PE) and polyethylene terephthalate (PET). This thermoplastic material can be added in powder form or in particle form or in fiber form to the plant particles and this before coating said plant particles. For example use can be made of PP fibers, PE fibers or PET fibers. This thermoplastic material can be present in the coating and/or in the glue. This thermoplastic material can be added separately when forming said board. With the aid of said thermoplastic material, edge swelling of the board material can be reduced and/or said board material can be less brittle. The dimensional stability can be improved.

Preferably, said coating comprises a thermoplastic material. Preferably said thermoplastic material is used in a mixture with another coating material, such as with a moisture cured or moisture curable coating material as mentioned above. The inventors have noted that the use of a thermoplastic material in said coating may lead to a better wetting of the plant particles and a resulting enhanced covering efficiency of said coating. With the aid of said thermoplastic material, edge swelling of the board material can be reduced and/or said board material can be less brittle. Examples of possible thermoplastic material are polyvinyl butyral (PVB) and/or ethylene vinyl acetate (EVA). Alternatively, or in combination, a wetting agent may be applied, such as a silicone polyether, for example the substance marketed as Andisil® SP 5100 marketed by AB Specialty Silicones. Other examples of possible thermoplastic material are polyvinyl chloride (PVC), polymethyl methacrylate (PMMA), polyurethane (PU), polypropylene (PP), polyethylene (PE), polyethylene terephthalate (PET), polyvinyl alcohol (PVA) and polybutylene succinate (PBS).

Preferably, said coating comprises an acrylate, an acrylate polymer or an acrylate derivative. Preferably said acrylate is used in a mixture with another coating material, such as with a moisture cured or moisture curable coating material as mentioned above, and/or said thermoplastic material. The inventors noted that the use of acrylate, acrylate polymer or acrylate derivative may lead to an enhanced flexibility of the obtained board material. Such flexibility may lead to an enhanced comfort and/or sound attenuation in use, for example when walking on a floor panel comprising such board material. The coating can comprise an epoxy acrylate or a polyester acrylate or an aliphatic acrylate. Preferably the acrylates are bifunctional acrylates.

It is remarked that said coating may comprise lignin or be based on lignin. Such coating may be more environmentally friendly and be more safe to apply than e.g. a coating of pMDI, or said coating comprising lignin can comprise less pMDI.

Preferably, said glue is a polycondensation glue, wherein preferably water is produced as a by-product. The water may partially be consumed by curing the coating on the plant particles, in case a moisture cured or moisture curable coating is used. More particularly, said glue comprises formaldehyde. The glue can comprise an aminoplast polymer, produced by a polycondensation reaction from urea and formaldehyde to a urea formaldehyde resin (UF resin). Optionally melamine is added and a melamine urea formaldehyde resin (MUF resin) is obtained, or melamine and/or phenol are added ((M)UPF resins: (melamine) urea phenol formaldehyde). More particularly, said glue may comprise ureaformaldehyde, melamine ureaformaldehyde or phenol ureaformaldehyde. The glue can also be melamineformaldehyde or phenolformaldehyde.

Other glues, such as starch and/or glucose and/or polyamine based glues are possible as well.

It is clear that the use of a moisture curable or moisture cured coating material in combination with a polycondensation glue yields a very interesting combination. Such embodiment brings about very good effects from the point of view of water resistance, and in particular results in a board material with low swelling, for example a swelling of less than 8% as measured according to EN 317:1993, or even better a swelling of 4% or less.

The coating material can comprise wax. For example the coating material can comprise between 0.01 and 20 weight percentage of wax, for example between 2 and 10 weight percentage of wax. For example the weight ratio of wax to the dry weight of plant particles can be between 0.1 and 10 percentage, for example between 0.5 and 2 percentage. The wax can be a polyolefin wax, such as a paraffin wax.

The board material can comprise additives, said additives preferably being chosen from the list of:
wax;
thermoplastic material, such as polyvinyl butyral or ethylene-vinyl acetate or styrene copolymer or PBS or PP or PE or PET or PVC or PMMA or polyurethane PU;
inorganic fillers such as CaCO₃, talc, vermiculite;
moisture absorbing material;
zero-poisson's ratio material;
epoxy;
thermo-initiator;
metallic soaps;
a silicon comprising compound, such as fumed silica or siloxanes or silazanes or silanes;
carbon black;
   preferably wherein the weight ratio of said additives to the dry weight of plant particles is between 0.1% and 10%, more preferably between 0.5% and 6%, most preferably between 1% and 5%, for example between 0.1% and 4% or between 0.5% and 2%.

A very suitable additive is a styrene butadiene copolymer. A very suitable combination of additives is a combination of a (carboxylated) styrene butadiene copolymer and CaCO₃. For example the weight ratio of CaCO₃ upon the total weight of additives can be between 10 wt % and 20 wt %.

With the aid of said additives a significant increase in water resistance can be obtained. The board can comprise one or more of the additives of the abovementioned list, wherein then preferably the weight ratio of all said additives to the dry weight of plant particles is between 0.1% and 10%, more preferably between 0.5% and 6%, most preferably between 1% and 5%, for example between 0.1% and 4% or between 0.5% and 2%.

Carbon black can be added in the form of a pigment, e.g. in powder form or in liquid form. Carbon black provides the board material with enhanced water resistant properties. Preferably the weight ratio of carbon black to the dry weight plant particles is between 0.1% and 2%. Preferably at least the coating comprises carbon black. In other embodiments, the glue comprises carbon black and/or carbon black is added before coating said plant particles.

In a specific embodiment said coating comprises said additives. By providing said additives to the coating, the plant particles are well shielded from water or moisture.

In another specific embodiment said glue comprises said additives. Water and/or moisture present around the board material can be well repelled if said glue comprises said additives.

In a specific embodiment said coating and said glue comprises said additives. The coating can or cannot comprise the same additives as the glue.

In a specific embodiment said additives are added before coating said plant particles. For example, wax can be added to the plant particles before coating said plant particles, for example in the form of a wax emulsion. In another specific embodiment said additives are added after gluing said coated plant particles. In another embodiment said additives are added between coating said plant particles and gluing said coated plant particles. Said additives in the two latter cases, can be added in powder form or in liquid form or in particulate form or in fiber form. For example adding said powder or liquid can be done when the mixture of glue and coated plant particles forms a matt to be pressed, for example can be added to the upper side and/or lower side of said matt. Optionally said additives in powder form and/or liquid form and/or particulate form and/or fiber form can be distributed throughout said matt with the aid of for example vacuum and/or moisture. The addition of said additives at said specific places lowers, among others, the edge swelling of the board material.

The composition of the board material, preferably expressed in dry matter weight, can be as follows:
between 40 and 90 weight percentage of dry plant particles, preferably between 50 and 80 weight percentage;
between 1 and 40 weight percentage of coating material, preferably between 15 and 30 weight percentage of coating material, for example between 20 and 25 weight percentage of coating material;
between 5 and 30 weight percentage of glue, preferably between 10 and 20 weight percentage;
between 0 and 10 weight percentage of wax and/or other additives as mentioned above, preferably between 1 and 5 weight percentage, for example 3 or 4 weight percentage.

With the same aim as in said first aspect, the present invention in accordance with its second aspect is a method for manufacturing a board material, wherein said method comprises at least the following steps:
the step of providing plant particles;
the step of applying a coating to said plant particles to obtain coated plant particles;
the step of providing a glue to said coated plant particles;
the step of pressing together said coated plant particles and said glue, and curing said glue.

It is possible to apply said coating on plant particles having a moisture content of 10% or more. This is a practical embodiment for example when working with a moisture curable coating. The moisture of the plant particles may at least partially be consumed for the curing of said coating. With the aid of a moisture curable coating, drying of said plant particles before applying said coating can be redundant or less drying can be needed. Drying can be used, especially if one wants to have more uniform process conditions and start with plant particles having a certain moisture content. The plant particles upon which said coating is applied can have a moisture content of 10%, 12%, 15% or 20% or can have a moisture content of less than 10%, for example 8% or 5%. Said moisture content is preferably wt %.

Preferably, said method further comprises a step of drying and/or curing said coated plant particles, preferably prior to providing said glue. Said step of drying and/or curing said coated plant particles preferably takes place between the step of applying a coating to said plant particles to obtain coated plant particles and the step of providing a glue to said coated plant particles. If gluing is done in a blowline, said drying and/or curing preferably takes place before said blowline, for example in a separate dryer and/or with the aid of a radiation device. Said drying can be a partial drying. Said curing can be a partial curing. Drying is for example interesting when the coating is moisture curable or moisture cured and the glue is a polycondensation glue. In such case, the curing can be controlled and stopped in a B-stage by drying, such that further moisture obtained from a polycondensation curing of the glue may lead to the final cure of said coating. In such case the final cure of the coating is obtained together with the cure or final cure of said glue. It is preferably in a heated pressing operation. In the heated press operation the temperature may for example reach a maximum between 15° and 250° C. The step of drying and/or curing can make use of one or more of the following: heat, turbulence, or radiation, such as for example UV, IR or NIR. Said drying and/or curing also helps to control the amount of moisture present. For example, the result of said step of drying and/or curing the coated plant particles, are coated plant particles having preferably a moisture content of at most 5 wt %, preferably at most 2 wt %.

Gluing of said coated plant particles can for example take place with the aid of a blowline. This can be for example the case when the plant particles are wood fibers. Coating of said plant particles then preferably takes place before the plant particles enter the blowline or in said blowline. Coating of said plant particles can take place in a separate first blowline, wherein gluing then takes place in a subsequent second blowline. Between said first and second blowline, a dryer and/or a radiation device can be present.

Gluing of said coated plant particles can take place with the aid of a gluing device, e.g. a device in which the coated plant particles are brought and in which the glue is brought and in which these coated plant particles and said glue are mixed together. This can be for example the case when the plant particles are wood chips. Coating of said plant particles then preferably takes place with the aid of a coating device, e.g. a device in which the plant particles are brought and in which the coating is brought and in which these plant particles and said coating are mixed together. Said gluing device and said coating device can be the same devices or can be similar devices. Between said coating device and said gluing device, a dryer and/or radiation device can be present. With the aid of a said dryer and/or radiation device can get (partially) cured.

The method can also comprise the step of applying additives to plant particles, for example in powder form or in liquid form or in particulate form or in fiber form, preferably before the said step of applying a coating to said plant particles, or during said step of applying a coating to said plant particles or during said step of providing a glue to said coated plant particles. The additives can be one or more chosen from the list of:
wax;
thermoplastic material, such as polyvinyl butyral or ethylene-vinyl acetate or styrene copolymer or PBS or PP or PE or PET or PVC or PMMA;
inorganic fillers such as CaCO₃, talc, vermiculite;
moisture absorbing material;
zero-poisson's ratio material;
epoxy;
thermo-initiator;
metallic soaps;
a silicon comprising compound, such as fumed silica or siloxanes or silanes or silazanes;
carbon black;
   preferably wherein the weight ratio of said additives to the dry weight plant particles is between 0.1% and 10%, more preferably between 0.5% and 6%, most preferably between 1% and 5%, for example between 0.1% and 4% or between 0.5% and 2%. Specific examples of the additives can be the examples of the additives mentioned in the first aspect of the invention. The amount and combinations of additives can be the same as mentioned in the first aspect of the invention.

Carbon black can be added in the form of a pigment, e.g. in powder form or in liquid form. Carbon black provides the board material with enhanced water resistant properties. Preferably the weight ratio of carbon black to the dry weight plant particles is between 0.1% and 2%.

Further said coating can be a coating as mentioned in the first aspect of the invention and/or also said glue can be the glue as mentioned in the first aspect of the invention.

Before the step of providing a glue to said coated plant particles, the moisture content of said coated plant particles can be adjusted if needed.

Before the step of pressing together said coated plant particles and glue, and curing said glue, the moisture content can be adjusted if needed.

The step of applying a coating to said plant particles to obtain coated plant particles, can be a one step process where coating material is applied to said plant particles, but can also comprise two or more steps. For example coating material can be applied during two or more subsequent steps, for example to apply different types of coating material. Of course the applied coating material can be a mixture of different types of coating material.

The step of pressing together said coated plant particles and said glue, and curing said glue, can be done in a continuous process, for example with the aid of a double belt press, or in a discontinuous process, for example with the aid of a single or multi daylight press. The pressing conditions can be as such, that the temperature first (gradually) increases to a maximum temperature, is kept a certain time at said maximum temperature and is then (gradually) decreased. The maximum pressure can be between 20 and 150 bar, for example be between 30 and 80 bar. The maximum temperature can be between 100° C. and 250° C.

Preferably, said method is applied for manufacturing a board material in accordance with said first aspect and/or the preferred embodiments thereof. The preferred and/or specific features of the first aspect of the invention therefore apply mutatis mutandis to the second aspect of the invention and vice versa.

With the same aim as in said first aspect, the present invention in accordance with its third aspect is a decorative panel, preferably a floor panel or wall panel or a furniture panel, comprising a substrate having one or more substrate layers and an applied thereon decorative top layer, wherein at least one of said substrate layers is obtained from a board material in accordance with said first aspect and/or the preferred embodiments thereof and/or from a board material manufactured in accordance with said second aspect and/or the preferred embodiments thereof.

Preferably, said decorative panel is rectangular and comprises two pairs of opposite edges, wherein said at least one substrate layer comprises an exposed portion at least at one of said edges. It are especially exposed portions that are vulnerable to deterioration by moisture. The use of the board material of the invention on an exposed portion thus enhances the water resistance of the decorative panel.

Preferably, said exposed portion is profiled and at least partially forms a first coupling part at the respective edge that allows said edge to be coupled to a second coupling part at the opposite edge of a similar decorative panel, wherein in the coupled condition a locking is obtained between the respective edges in a direction perpendicular to the plane of coupled panels and/or in the plane of coupled panels and perpendicular to the respective edges. Such profiled edges allow for an installation without the application of a separate glue on the edges of the decorative panels. Such floating installations may be particularly vulnerable to water or other moisture entering the joints between thus coupled edges. Preferably a water repellent coating and/or an impregnation agent is applied to at least one of said edges. Such water repellent coating or impregnation agent may repel water from entering in the seam between two coupled panels at the respective edges. Although any water penetrating in the seam may be harmless seeing the enhanced quality of the substrate applied in the decorative panels of the present invention, such water may reach the bottom of the decorative panels and remain standing under a floor covering assembled from such panels. This may lead to the growing of mold and bad odors.

The decorative top layer can comprise one or more of the following:
a resin impregnated paper, the resin can be for example a melamine resin or an acrylate resin, if the resin is an acrylate resin, then said resin impregnated paper can be covered with a lacquer layer, for example an embossable lacquer layer;
a plastic sheet, for example a thermoplastic based sheet being a layer comprising thermoplastic material and optionally inorganic/organic fillers and optionally plasticizers material wherein the thermoplastic material can or cannot make up at least half of the weight of said layer, with the thermoplastic material being for example PVC, PP, PE, PET;
a wood veneer;
a timber layer;
a coating, which has been for example UV and/or heat cured;
a textured layer;
a lacquer;
an oil layer;
a foamed layer;
a metal layer, such as a metal foil or a metal coating;
a scrim or a net, such as a glass fiber scrim;
a print layer, for example a print layer obtained by direct printing or a printed sheet or a printed paper. The printing can be done digitally or analogously.

The decorative top layer can comprise a sublayer that can be described by one or more of the abovementioned terms. For example the sublayer can be resin impregnated printed paper, such that it is also a print layer, further said sublayer can have a texture and then is also a textured sublayer.

With the same aim as in said first aspect, the present invention in accordance with its fourth aspect is a board material comprising plant particles, wherein said plant particles have a charred surface and are pressed and bound together with a glue. The inventors have noted that a charred surface of a plant particle also to some extent lowers the water absorption into the particle, and the functionality of a charred surface is comparable to the coating mentioned in the context of the first till third aspect. It is of course not excluded that plant particles having a charred surface are provided with an additional coating as described in said first till third aspect. A said board material according to the fourth aspect of the invention, can thus also be according to the first aspect of the invention.

It is clear that particular plant particles or plant fibers as mentioned in said first till third aspect are also preferred in the context of the present fourth aspect. Thus, the plant particles may show one or more of the following features:
the feature that said plant particles comprise particles of wood in fiber or particulate form;
the feature that said plant particles comprise wood fibers, wherein said wood fibers have an aspect ratio (length:diameter) between 25 and 100;
the feature that said plant particles comprise particles of a wood species having a density, for example an average density, at 12% moisture of at least 400 kg/m³ or at least 500 kg/m³;
the feature that said plant particles comprise particles of soft wood;
the feature that the plant particles in said board materials are essentially or exclusively obtained from wood, preferably either softwood or hardwood;
the feature that said plant particles comprise particles of hemp, bamboo and/or miscanthus.

Said plant particles can also be recycled plant particles.

Preferably, said glue is a polycondensation glue, wherein preferably water is produced as a by-product.

Preferably, said glue comprises formaldehyde, preferably said glue comprises ureaformaldehyde, melamineformaldehyde, melamine ureaformaldehyde and/or phenolformaldehyde.

It is clear that the glue as mentioned in said first till third aspect are also preferred in the context of the present fourth aspect.

It is clear that the additives as mentioned in said first till third aspect are also preferred in the context of the present fourth aspect.

With the same aim as in said first aspect, the present invention in accordance with its fifth aspect is a board material comprising plant particles, wherein said plant particles are modified plant particles, for example acetylated plant particles and/or delignified plant particles and/or thermally modified plant particles and/or silanized plant particles, wherein said modified plant particles are pressed and bound together with a glue, wherein said modified plant particles are preferably modified lignocellulosic particles. The inventors have noted that such modified plant particles also to some extent lower the water absorption into the particle. It is of course not excluded that the modified plant particles are provided with an additional coating as described in said first till third aspect and/or that said modified plant particles also comprise a charred surface as described in said fourth aspect. A said board material according to the fifth aspect of the invention, can thus also be according to the first aspect of the invention and/or according to the fourth aspect of the invention.

It is clear that particular plant particles or plant fibers as mentioned in said first till fourth aspect are also preferred in the context of the present fifth aspect.

It is clear that the glue as mentioned in said first till fourth aspect are also preferred in the context of the present fifth aspect.

It is clear that the additives as mentioned in said first till fourth aspect are also preferred in the context of the present fifth aspect.

With same goal as the above-mentioned aspects of the invention, the invention, according to a sixth aspect of the invention, relates to a board material comprising plant particles, for example lignocellulose particles, wherein said plant particles are pressed and bound together with a glue and wherein said board material comprises additives, said additives being chosen from the list of:
thermoplastic material, such as polyvinyl butyral or ethylene-vinyl acetate or styrene copolymer or PP or PE or PBS or PET or PVC or PMMA;
inorganic fillers such as CaCO₃, talc, vermiculite, MgO;
moisture absorbing material;
zero-poisson's ratio material;
metallic soaps;
thermo-initiator;
epoxy;
a silicon comprising compound, such as fumed silica or siloxanes or silanes;
carbon black;
   preferably wherein the weight ratio of said additives to the dry weight plant particles is between 0.1% and 10%, more preferably between 0.5% and 6%, most preferably between 1% and 5%.

Carbon black can be added in the form of a pigment, e.g. in powder form or in liquid form. Carbon black provides the board material with enhanced water resistant properties. Preferably the weight ratio of carbon black to the dry weight plant particles is between 0.1% and 2%. Preferably at least the coating comprises carbon black. In other embodiments, the glue comprises carbon black and/or carbon black is added before coating said plant particles.

It is clear that particular plant particles or plant fibers as mentioned in said first till fifth aspect are also preferred in the context of the present sixth aspect.

It is clear that the glue as mentioned in said first till fifth aspect are also preferred in the context of the present sixth aspect.

It is clear that the abovementioned additives of the sixth aspect of the invention can be the same as mentioned in said first till fifth aspect.

Preferably said board material according to the sixth aspect of the invention does not comprise coated plant particles as described in the first aspect of the invention. The first aspect of the invention can have the same additives as the sixth aspect of the invention. The features, benefits, amounts of said additives described in the first aspect of the invention, also relate to this sixth aspect of the invention. Preferably said glue comprises said additives. Said additives can be added in liquid form or in powder form or in particle form or in fiber form. For example thermoplastic additives, such as PET, PP and PE can be added in fiber form. If said additives are in powder form or fiber form, it is also beneficial to add said additives to the plant particles and this before applying the glue to the plant particles. Of course additives in powder form or fiber form can also be added to the glue.

For example, it has been found that a board material comprising thermoplastic material as additives, such as PBS, PVB PP, PE, PET and/or styrene butadiene copolymer, show a significantly reduced edge swell and absorption with respect to similar board material not comprising said thermoplastic material. Styrene butadiene copolymer has been found to be a very good additive for board material which are bonded together with an MDI glue, and significantly reduces the edge swell. Styrene butadiene copolymer, such as carboxylated styrene butadiene copolymer, bonds very well with MDI.

For example, it has been found that a board material comprising epoxy compounds as additives, show a significantly reduced edge swell and absorption with respect to similar board material not comprising said epoxy compounds. Epoxy compounds have been found to be a very good additive for board material which are bonded together with an MDI glue, and significantly reduces the edge swell.

Further it has also been found that a combination of metallic soaps, such as zinc stearate, and inorganic fillers such as CaCO₃, as additives for the board material, not only reduce the edge swell and absorption of board materials, but also significantly improves the dimensional stability of this boards. For example the weight ratio of said metallic soaps to the dry weight of plant particles is between 2% and 6%, for example 5%, and the weight ratio of said inorganic fillers to the dry weight plant particles is between 0.5% and 2%, for example 1%. The weight ratio inorganic fillers to metallic soap is preferably between 10% and 30%, for example 20%.

When the additives comprise silicon containing compounds, such as polysiloxanes, polysilazanes or polysilanes, the edge swell and absorption of board materials is also significantly reduced.

From the above it is clear that the additives can comprise a single type of component, but that the additives can also be a combination of different types. For example the additives can be a combination of fumed silica and a styrene butadiene copolymer, wherein preferably the weight ratio of said styrene butadiene copolymer to the dry weight plant particles is between 2% and 10%, for example 5%, and the weight ratio of said fumed silica to the dry weight plant particles is between 0.1% and 0.5%, for example 0.25%. The weight ratio fumed silica to styrene butadiene copolymer is preferably between 3% and 7%, for example 5%.

The combination of MDI glue and a styrene butadiene copolymer as additive has also been found to result in board materials with the desired characteristics.

In a specific embodiment the glue is a combination of MDI and an acrylate, for example a bifunctional acrylate, for example an epoxy acrylate, a polyester acrylate or an aliphatic acrylate. Said glue can be present in an amount between 15 and 25 wt % based upon the dry weight of the plant particles. Said glue for example comprises between 30 and 70% MDI upon the total weight of glue. It has been found that for this glue thermoplastic material as an additive, such as styrene butadiene copolymer, enhances the water resistant characteristics of the board significantly. The presence of an acrylate significantly improves the dimensional stability.

According to a variant, the glue mentioned in the sixth aspect of the invention, can also be used to impregnate a paper, as such to form a resin impregnated paper. The invention, according to this variant, thus also relates to a glue for impregnating papers.

It is clear that the present invention, in accordance with a seventh aspect, is a decorative panel, preferably a floor panel or wall panel or a furniture panel, comprising a substrate having one or more substrate layers and an applied thereon decorative top layer, characterized in that at least one of said substrate layers is obtained from a board material in accordance with said fourth or fifth or sixth aspect and/or the preferred embodiments thereof.

Preferably, said decorative panel is rectangular and comprises two pairs of opposite edges, wherein said at least one substrate layer comprises an exposed portion at least at one of said edges. Preferably, said exposed portion is profiled and at least partially forms a first coupling part at the respective edge that allows said edge to be coupled to a second coupling part at the opposite edge of a similar decorative panel, wherein in the coupled condition a locking is obtained between the respective edges in a direction perpendicular to the plane of coupled panels and/or in the plane of coupled panels and perpendicular to the respective edges. Preferably a water repellent coating or impregnation agent is applied to at least one of said edges. Such water repellent coating or impregnation agent may repel water from entering in the seam between two coupled panels at the respective edges. Although any water penetrating in the seam may be harmless seeing the enhanced quality of the substrate applied in the decorative panels of the present invention, such water may reach the bottom of the decorative panels and remain standing under a floor covering assembled from such panels. This may lead to the growing of mold and bad odors.

In general, in accordance with any of the above mentioned aspects, said board material or substrate layer preferably has a thickness of 1.5 to 15 mm, or even more preferably of 3 to 6 mm. A thickness of about 4.5 mm is a good value.

Preferably the substrate layer and/or substrate mentioned in the third and seventh aspect form at least half the thickness of the respective decorative panel.

The coupling parts mentioned in connection with preferred embodiments of said third and/or seventh aspect are preferably realized entirely from the material of the respective decorative panel, more particularly essentially from said substrate.

Said decorative top layer, as mentioned in said third and/or seventh aspect, may comprise a printed pattern, a wood veneer or a stone or ceramic material. Most preferably, according to said third and/or seventh aspect, said decorative top layer comprises a printed pattern and a transparent or translucent top layer applied on top of said printed pattern. Said printed pattern may be applied on a carrier material, such as on a paper or plastic foil. According to an alternative embodiment said printed pattern is formed by applying inks directly to said substrate, whether or not with the intermediate of one or more primer layers. In such case the transparent or translucent top layer may comprise a thermoplastic or thermoset resin and/or a radiation or heat cured lacquer.

According to the most preferred embodiment of said third and/or seventh aspect, said decorative top layer is formed by means of the so-called DPL method. Herein a printed decorative paper is provided with a thermosetting resin, for example with melamine resin or an acrylate resin or a resin which is a glue according to the abovementioned variant. The resin provided paper is then, at elevated temperature pressed together with a substrate, in the case of this invention, obtained from a board material in accordance with the first and/or fourth and/or fifth and/or sixth aspect and/or the preferred embodiments thereof. The pressing operation cures the resin, and the resin flow in the press is such that it also creates adherence between the resin provided paper and the substrate. Preferably, in the same pressing operation a transparent or translucent resin layer is obtained on top of said paper, for example by means of a transparent or translucent second resin provided paper layer, or, in other words, a so-called overlay.

Alternative possibilities of said third and/or seventh aspect, for providing said decorative top layer include gluing a prefabricated printed paper or foil to said substrate. The prefabricated printed paper may be impregnated with a resin, e.g. with an acrylate. The glue may for example be a two component polyurethane and isocyanate glue, for example applied at a rate of 20 to 40 grams per square meter. A transparent or translucent layer may be formed on said printed paper layer by means of radiation curable lacquer. The curing may be performed before the gluing step, for example by means of ultraviolet or electron beam curing. In the case a printed foil is used, this may for example be a printed foil of polyethylene terephthalate, glycol modified polyethylene terephthalate, polyethylene or polypropylene.

At one or more edges of a pair of opposite edges said decorative panel of said third and/or seventh aspect, may be provided with lowered edge areas, for example inclining downwards from the global upper surface, or, in other words in the form of a bevel. Such bevel may be formed by removing a portion of said decorative top layer at the respective edge. In such case, the obtained beveled surface may be provided with a separate decoration, for example formed by a liquidly applied colorant, such as an ink, lacquer or paint. In accordance with an alternative the bevel is formed such that the decorative top layer extends uninterruptedly from the global upper surface of the decorative panel towards and on said lowered edge area, preferably up to the respective upper edge of the decorative panel. Such bevel may be obtained by deforming at least said substrate for example by pressing down the edge.

In general, the board materials and/or decorative panels of the present invention in accordance with any of the above mentioned aspects have a swelling of less than 8% as measured according to EN 317:1993, or even better a swelling of 4% or less and even more better a swelling of less than 1%.

In general, the board materials and/or decorative panels of the present invention in accordance with any of the above mentioned aspects can have an edge swelling of less than 8% as measured according to EN 13329:2016 or measured according to ISO 24336, or even better an edge swelling of 5% or less and even more better an edge swelling of less than 3%.

In general, the board materials of the present invention in accordance with any of the above mentioned aspects comprise at least 65% by weight of said (coated) plant particles and/or charred plant particles. Preferably, said board materials comprise 35% by weight or less of said glue. Preferably said coating and said glue make up for at least 15% by weight of said board material.

According to a first variant of all the aspects of the invention, said plant particles can be completely or at least partially replaced by alternative particles which are less prone to swelling, for example ceramic particles, plastic particles or metallic particles. For example the weight ratio alternative particles:plant particles can be between 1:2 and 1:20, for example can be 1:4 or 1:8 or 1:12. A first example of such a first variant, is a board material wherein all the plant particles are replaced by a mineral, for example by mineral fibers. Said mineral can be magnesium oxide. A second example of such a first variant, is a board material wherein the plant particles are partially replaced by a mineral, for example by mineral fibers. Said board material can comprise a combination of magnesium oxide and wood fibers.

The invention also relates to a glue as such, wherein said glue is a glue as mentioned in the abovementioned aspects and comprises said additives.

The invention also relates to a coating as such, wherein said coating is a coating as mentioned in the abovementioned aspects and comprising said additives.

With a view to providing a better illustration of the characteristic features of the invention, the following text describes a number of possible embodiments by way of example, without any limiting character.

The invention, according to embodiments, relates to board material comprising wood particles comprising a coating on a surface thereof, wherein said wood particles are pressed and bound together with a glue. Said wood particles can be wood chips or said wood particles can be wood fibers.

Preferably said wood particles are at least partially derived from soft wood, preferably are substantially or completely derived from soft wood.

Here below certain compositions of coatings and glues are described:
coating 1: polyurethane modified alkyd
coating 2: emulsion of acrylate
coating 3: mixture of polyurethane modified alkyd and an emulsion of acrylate
glue 1: epoxy resin
glue 2: styrene acrylate
glue 3: latex modified acrylate
glue 4: urea formaldehyde glue

Coating 1 and also coating 2 and also coating 3 could be used in combination with the abovementioned four glues.

These coatings are used to coat said wood particles and between 1 wt % and 40 wt % of coating is used, based upon the dry weight of said wood particles. Preferably the coatings are used in such an amount that approximately the entire surface of the wood particles is coated with said coating.

Glue is then applied upon these coated wood particles to form a cake and said cake is then pressed to form said board material.

This board material as such can be used to form a panel, for example a construction panel. Said board material can also be used to form the substrate or be part of the substrate of a decorative panel, for example a floor panel, a wall panel or a furniture panel.

Said wood particles, prior to said coating, can have undergone an additional treatment as such to improve the characteristics of the obtained board material. For example said wood particles can have had one or more of the following treatments:
heat treatment to form thermally modified wood particles;
delignification treatment to form delignified wood particles;
an acetylation treatment to form acetylated wood particles;
a silanization treatment to form silanized wood particles.

Other compositions of coatings and glues are described below:
Coating 1: carboxylated styrene-butadiene copolymer with latex
Coating 2: epoxy resin
Coating 3: epoxy resin combined with an amine functional siloxane
Glue 1: melamine formaldehyde
Glue 2: MDI
Glue 3: acrylate

Here below some examples of board materials and test results of board materials mentioned above and other board materials according to the invention, are discussed:

### EXAMPLE 1: BOARD MATERIAL ACCORDING TO THE SIXTH ASPECT OF THE INVENTION

The board material comprises wood particles, e.g. wood chips. Said wood chips have been pressed and bound together with a glue and this preferably with the aid of a double belt press. Further said board material comprises additives, the amount of additives is preferably between 1 wt % and 7 wt % based upon the dry weight of said wood particles, e.g. 5 wt %. Said additives are preferably added to said glue when forming the board material, but could also be added to said wood particles before, during or after the addition of glue to said wood particles. The following additives were evaluated: PVB, PBS, styrene butadiene copolymer, metal soap and fumed silica. The glue is a melamine formaldehyde glue (MF glue). The board materials were compared with a board material comprising wood chips and a melamine formaldehyde glue and no further additives (Tests 1 and 2). The edge swell was measured according to EN 13329:2016, the total absorption was measured according to EN 13329:2016 and the dimensional stability (Dim Stab) was also measured according to EN 13329:2016.

| | | | | | wt % | wt % | | | |
|---|---|---|---|---|---|---|---|---|---|
| | wt % | wt % | wt % | | fumed | metal | | | |
| | MF-glue | PVB | PBS | wt % | silica | soap | | | |
| | upon | upon | upon | styrenebutadiene | upon | upon | | Edge | DIM |
| | wood | wood | wood | copolymer upon | wood | wood | absorption | swell | stab |
| Test | chips | chips | chips | wood chips | chips | chips | % | % | (mm/m) |
| 1 | 15 | 0 | 0 | 0 | 0 | | 17.0 | 10.1 | 3.5 |
| 2 | 25 | 0 | 0 | 0 | 0 | | 15.0 | 6.6 | 3.8 |
| 3 | 15 | 0 | 0 | 5 | 0 | | 16.0 | 4.5 | 3.4 |
| 4 | 15 | 5 | 0 | 0 | 0 | | 13.5 | 5.2 | 3.5 |
| 5 | 15 | 0 | 5 | 0 | 0 | | 12.6 | 6.5 | 2.7 |
| 6 | 15 | 0 | 0 | 0 | 5 | | 16.1 | 7.5 | 3.5 |
| 7 | 15 | 0 | 0 | 0 | 0 | 5 | 13.1 | 6.2 | 3.2 |

From the above, it is clear that adding styrene butadiene copolymer as an additive significantly lowers the edge swell. Adding PVB as an additive significantly lowers the edge swell and absorption. Adding PBS as an additive significantly lowers the edge swell and absorption, but also significantly improves the dimensional stability. Adding fumed silica lowers the edge swell. Adding metal soap lowers the edge swell. The advantage of said additives, is that smaller amounts are needed to improve the characteristics of the board material and as such less glue is required.

### EXAMPLE 2: BOARD MATERIAL ACCORDING TO THE SIXTH ASPECT OF THE INVENTION

The board material comprises wood particles, e.g. wood chips. Said wood chips have been pressed and bound together with a glue and this preferably with the aid of a double belt press. Further said board material comprises additives, the amount of additives is preferably between 1 wt % and 10 wt % based upon the dry weight of said wood particles, e.g. 5 or 7 wt %. The following additives were evaluated: PVB, carboxylated styrene butadiene copolymer, metal soap, CaCO₃ and fumed silica. Said additives are preferably added to said glue when forming the board material, but could also be added to said wood particles before, during, or after the addition of glue to said wood particles. The glue is an MDI glue. The board materials were compared with a board material comprising wood chips and an MDI glue and no further additives (Test 1). The edge swell was measured according to EN 13329:2016, the total absorption was measured according to EN 13329:2016 and the dimensional stability (Dim Stab) was also measured according to EN 13329:2016.

| | | | wt % | | | | wt % | | | | |
|---|---|---|---|---|---|---|---|---|---|---|---|
| | wt % | | styrene | wt % | | | epoxy + | wt % | | | |
| | MDI- | wt % | butadiene | fumed | | | amine | PP/PE | | | |
| | glue | PVB | copolymer | silica | | | hardeners | fibers | | | |
| | upon | upon | upon | upon | wt % | | upon | upon | | Edge | DIM |
| | wood | wood | wood | wood | metal | wt % | wood | wood | Absorption | swell | stab |
| Test | chips | chips | chips | chips | soap | CaCO₃ | chips | chips | % | % | (mm/m) |
| 1 | 20 | 0 | 0 | 0 | 0 | 0 | 0 | 0 | 24.0 | 12.0 | 3.9 |
| 2 | 20 | 5 | 0 | 0 | 0 | 0 | 0 | 0 | 8 | 6.1 | 2.6 |
| 3 | 20 | 0 | 5 | 0 | 0 | 0 | 0 | 0 | 12 | 4.2 | 3.8 |
| 4 | 20 | 0 | 0 | 5 | 0 | 0 | 0 | 0 | 9.0 | 6.2 | 3.9 |
| 5 | 20 | 0 | 0 | 0 | 5 | 0 | 0 | 0 | 10.0 | 7.1 | 3.9 |
| 6 | 20 | 0 | 0 | 0 | 5 | 1 | 0 | 0 | 10.0 | 6.9 | 3.1 |
| 7 | 20 | 10 | 0 | 0 | 0 | 0 | 0 | | 8.8 | 3.6 | 2.7 |
| 8 | 20 | 2.5 | 2.5 | 0 | 0 | 0 | 0 | 0 | 7.8 | 4.5 | 2.5 |
| 9 | 20 | 0 | 0 | 0 | 0 | 0 | 0 | 10 | 5.6 | 4.6 | 2.0 |
| 10 | 20 | 0 | 0 | 0 | 0 | 0 | 5 | 0 | 7.8 | 4.5 | 2.5 |

From the above, it is clear that adding styrene butadiene copolymer or PVB or fumed silica or metal soaps or PP/PE fibers or epoxy as additive, significantly lowers the edge swell and absorption. Further PVB and epoxy's and PP/PE fibers also significantly improve the dimensional stability. It can also be seen that the combination of metal soap and CaCO₃ improves dimensional stability.

### EXAMPLE 3: BOARD MATERIAL ACCORDING TO THE FIRST ASPECT OF THE INVENTION

The board material comprises wood particles, e.g. wood chips. Said wood chips have been coated with a coating to form coated wood chips. Said coated wood chips have been pressed and bound together with a glue and this preferably with the aid of a double belt press. Further said board material could comprise additives, the amount of additives is preferably between 1 wt % and 7 wt % based upon the dry weight of said wood particles, e.g. 5 wt %. Said additives could be added to said wood particles before, during, or after the addition of glue or coating to said wood particles. The glue is an MDI glue. The board materials were compared with a board material comprising wood chips and an MDI glue and no further additives (Test 1). The edge swell was measured according to EN 13329:2016, the total absorption was measured according to EN 13329:2016 and the dimensional stability (Dim Stab) was also measured according to EN 13329:2016.

| | | | | wt % | | | |
|---|---|---|---|---|---|---|---|
| | | | | carboxylated | | | |
| | | wt % | | styrene | | | |
| | wt % | epoxy | wt % | butadiene | | | |
| | MDI-glue | coating | polysiloxanes | copolymer | | | |
| | upon | upon | coating | coating | | Edge | DIM |
| | wood | wood | upon wood | upon wood | Absorption | swell | stab |
| Test | chips | chips | chips | chips | % | % | (mm/m) |
| 1 | 20 | 0 | 0 | 0 | 24.0 | 12.0 | 3.9 |
| 2 | 20 | 0 | 0 | 40 | 6.6 | 3.7 | 2.2 |
| 3 | 20 | 20 | 0 | 0 | 6.8 | 3.6 | 2.1 |
| 4 | 20 | 20 | 20 | 0 | 6.5 | 5.3 | 2.1 |
| 5 | 20 | 10 | 10 | 0 | 5.5 | 3.4 | 3.2 |

In test 5 the polysiloxanes were amine-functionalized, while in test 4 the polysiloxanes were not amine-functionalized.

From the above, it is clear that said coatings significantly lower the edge swell, also the dimensional stability is improved.

The present invention is not limited to the preferred embodiments described above, but such panels and methods may be realized according to several variants without leaving the scope of the invention.

1.-37. (canceled)

38. A board material comprising plant particles, said plant particles comprising a coating on a surface thereof, wherein said plant particles are pressed and bound together with a glue.

39. The board material in accordance with claim 38, wherein said plant particles comprise particles in fiber form, or in particulate form.

40. The board material in accordance with claim 38, wherein said plant particles comprise wood fibers,
wherein said wood fibers have an aspect ratio (length:diameter) between 25 and 100.

41. The board material in accordance with claim 38, wherein said plant particles comprise one, two, three or four of the following features:
said plant particles comprise particles of a wood species having an average density at 12% moisture of at least 400 kg/m³ or at least 500 kg/m³;
said plant particles comprise particles of soft wood;
said plant particles are essentially or exclusively obtained from wood;
said plant particles comprise particles of hemp, bamboo and/or miscanthus.

42. The board material in accordance with claim 38, wherein said glue has a composition different from said coating.

43. The board material in accordance with claim 38, wherein said coating is applied on at least 50% of the surface of said plant particles.

44. The board material in accordance with claim 38, wherein said coating encapsulates said plant particles.

45. The board material in accordance with claim 38, wherein said coating is moisture cured or moisture curable.

46. The board material in accordance with claim 38, wherein said coating is radiation cured or radiation curable.

47. The board material in accordance with claim 38, wherein said coating comprises cured pMDI (polymeric methylene diphenyl diisocyanate).

48. The board material in accordance with claim 38, wherein said coating comprises a thermoplastic material.

49. The board material in accordance with claim 38, wherein said coating comprises acrylate.

50. The board material in accordance with claim 38, wherein said coating comprises additives, said additives being chosen from the list of:
wax;
thermoplastic material;
inorganic fillers;
moisture absorbing material;
zero-poisson's ratio material;
metallic soap;
a silicon comprising compound;
epoxy a thermo-initiator;
carbon black;
wherein the weight ratio of said additives to the dry weight plant particles is between 0.1% and 10%.

51. The board material in accordance with claim 38, wherein said glue is a polycondensation glue and/or said glue comprises ureaformaldehyde, melamineformaldehyde, melamine ureaformaldehyde, phenol ureaformaldehyde and/or phenolformaldehyde.

52. The board material in accordance with claim 38, wherein said glue comprises additives, said additives being chosen from the list of:
wax;
thermoplastic material;
inorganic fillers;
moisture absorbing material;
zero-poisson's ratio material
metallic soap;
a silicon comprising compound;
epoxy;
a thermo-initiator;
carbon black;
wherein the weight ratio of said additives to the dry weight plant particles is between 0.1% and 10%.

53. The board material in accordance with claim 38, wherein said plant particles have a charred surface.

54. The board material according to claim 38, wherein said plant particles are acetylated plant particles and/or delignified plant particles and/or thermally modified plant particles and/or silanized plant particles.

55. A method for manufacturing a board material, wherein said method comprises at least the following steps:
the step of providing plant particles;
the step of applying a coating to said plant particles to obtain coated plant particles;
the step of providing a glue to said coated plant particles;
the step of pressing together said coated plant particles and said glue, and curing said glue.

56. The method in accordance with claim 55, wherein said method further comprises a step of drying said coated plant particles, prior to providing said glue.

57. The method in accordance with claim 55, wherein said method further comprises a step of curing said coated plant particles, prior to providing said glue.
